(19) United States
(12) Patent Application Publication
(10) Pub. No.: US 2010/0191677 A1
(43) Pub. Date: Jul. 29, 2010

(54) EGG TRANSPORT CONTAINER AND MULTI-USE INSERT FOR AN EGG TRANSPORT CONTAINER

(75) Inventor: Christoph Hönig, Muhlingen (DE)

Correspondence Address: LERNER GREENBERG STEMER LLP, P O BOX 2480, HOLLYWOOD, FL, 33022-2480, US

(73) Assignee: HÖNIG-HOF GMBH, Muhlingen (DE)

(21) Appl. No.: 12/692,842

(22) Filed: Jan. 25, 2010

(30) Foreign Application Priority Data
Jan. 23, 2009 (DE) 10 2009 006 001.4

(51) Int. Cl. B65D 85/32; B65D 81/02; B65D 1/36; B65D 25/00; B65D 25/28; A47J 43/04; G06Q 90/00; A23L 1/01

(52) U.S. Cl. 705/500; 206/521.15; 220/508; 220/745; 220/752; 99/440; 426/300

(57) ABSTRACT

An egg transport container for transporting and storing a number of eggs has an outer container encompassing the eggs and at least one insert, disposed in the container and removable from the container, for securing at least one egg within the container. As a result of the removability of the insert from the container, the insert, together with the eggs, can be placed directly into a pan for boiling the eggs. A merchandising system provides for those consumers who bring the container to the merchant's for transporting eggs to be purchased, to have their egg purchased discounted due to the savings in packaging and waste management.

### CROSS-REFERENCE TO RELATED APPLICATION

This application claims the priority, under 35 U.S.C. §119, of German patent application DE 10 2009 006 001.4, filed Jan. 23, 2009; the prior application is herewith incorporated by reference in its entirety.

### BACKGROUND OF THE INVENTION

### Field of the Invention

The invention relates to an egg transport container for transporting and storing a plurality of eggs and to an insert for an egg transport container.

In retailing, eggs are usually offered for sale in cardboard or pressed foam cartons, in which six or ten eggs are respectively packed, held individually in a tray. The cartons are disposable containers, which are dumped after use, or they are recycled. To save resources, multipacks are desirable.

### SUMMARY OF THE INVENTION

It is accordingly an object of the invention to provide an egg container which overcomes several disadvantages of the heretofore-known devices and methods of this general type and which provides for an egg container in which eggs can be safely and hygienically transported and stored, as well as further processed.

With the foregoing and other objects in view there is provided, in accordance with the invention, an egg transport container for transporting and storing a plurality of eggs, comprising:

an outer container;

at least one insert removably disposed in said outer container, said at least one insert being configured to secure one or more eggs within said container.

In other words, the objects of the invention are achieved by an egg transport container for transporting and storing a number of eggs, which, according to the invention, has an outer container encompassing the eggs and at least one insert, disposed in the container and removable from the container, for securing at least one egg within the container. As a result of the removable insert, the container can be easily cleaned, for example in a dishwasher. Moreover, the insert can be used outside the container for a further application.

A further object of the invention is therefore to define an advantageous use of an insert of an egg transport container.

This object is achieved according to the invention by a use of an insert of an egg transport container as a device for holding eggs in a pan in the boiling of eggs. The insert can be removed from the container of the egg transport container and placed with the eggs directly into a pan of water, in which the eggs are boiled. After boiling, the insert with the boiled eggs can be taken out of the water and held, and, for example, deposited, under cold water. Likewise advantageously, the insert can be removed from the container and placed with the eggs directly into the refrigerator, for example in its egg compartment.

The container can be produced from a plastic, expediently a dishwasher-proof plastic, and advantageously has predominantly smooth surfaces, in particular is smooth over 90% of its outer and inner surface or is provided with a merely small, easy to clean structure. Expediently, the container, at least in a lateral region, is transparent to the point where its content can be recognized from outside. This facilitates the visual inspection of the content at the cashpoint of a shop and within the home, so that it is easy to tell how many eggs are in the container from the outside.

The insert can be produced from the same material as the container and can be removed from the container and deposited back downward into the same. The insert is shaped such that the eggs held therein, when the insert is removed from the container, are jointly removed from the container and continue to be safely stored in the insert.

The container can have a bottom tray and a lid for closure of the bottom tray and can be realized as a box. The container is advantageously realized, with lid and bottom tray, in one piece. The lid is expediently fastened to the bottom tray with a film hinge and can be swung down onto the bottom tray for closure of the egg transport container. For the secure closure of bottom tray and lid, these two elements, in the closed state, expediently interlock, for example by tongue and groove.

In addition, it is advantageous if the hinged lid can be latched for closing effect to the bottom tray with a closing mechanism and the closing mechanism has two mutually separate and mutually redundant latching elements for the mutually independent closure of the lid. If the lid is inadvertently not quite properly closed, then there is nevertheless a high probability that at least one of the latching elements shall be engaged and shall hold the lid sufficiently securely closed.

Advantageously, the container is provided with at least one air vent. This can be made in the lid, expediently in a ceiling of the lid, i.e. in its top side.

For the secure stacking of a plurality of egg transport containers one above the other, the container is advantageously provided, in a side lying opposite the air vent, with a molding for engaging in an air vent of a further egg transport container stacked above or below. In this way, a plurality of egg transport containers stacked one above the other are prevented by the engagement of the molding—expediently by the engagement of a plurality of moldings in a plurality of air vents—from slipping relative to one another.

A good protection of the eggs against damage in the container in case of impacts against the container can be obtained if the insert, in a transport state of the egg transport container, is kept distant from all side walls of the container. To this end, the container and the insert can form a form closure, which holds the insert in a fixed position in the container.

In a further advantageous embodiment of the invention, the insert is provided with a standing element or foot for standing on a base of the container, the standing element and the base forming a form closure. A stable mounting of the insert in the container can thereby be achieved, so that the insert—despite a possible distancing from the side walls of the container—is secured against slippage in the container. Expediently, the form closure secures the insert against slippage on the base in two mutually perpendicular directions. The insert is hence fixed two-dimensionally to the base, so that it expediently can only be removed upward from the container, i.e. in one direction. As a result of the form closure, the insert can advantageously, in a transport state, be held distant from all side walls of the container, so that impacts upon the container cannot be transmitted directly to the stored eggs.

The form closure advantageously extends over more than 1 mm, in particular more than 2 mm, in the vertical direction. It stays like this if the closed container is held above head height, so that the insert remains in its position defined by the form closure, even assuming a small vertical clearance, in any position of the closed container.

When the container is closed, the insert is expediently fixed in the container in all three spatial dimensions. A fixing in the upward direction can be realized by an element of the insert, for example a handle element, coming to bear against the lid.

It is also sufficient if the insert is of such a height that it has a vertical clearance of less than 1 mm to a horizontal and highest region of the lid of the container when the container is closed. If the lid, in its middle, for example, is pressed from above, then it comes to lie against the insert, which supports the lid against being pressed in further. The container hence acquires high stability and the eggs are protected from a pressure from above.

In a further advantageous embodiment of the egg transport container, the insert is mounted in the container with a defined lateral clearance of between 1 mm and 3 mm, so that the insert and the eggs stored therein, in case of a lateral impact, move sideways en bloc in accordance with the clearance. In case of small impacts or stronger vibrations, the insert with the eggs is displaced in the container, so that the impact energy is not transmitted to the eggs, or is transmitted thereto only in small share. The effect of this is that the eggs in the insert rattle less than in an insert fixed rigidly in the container.

A further embodiment of the invention provides that the insert is provided with a foot for standing on a base of the container, and the foot has a molding for standing punctiformly on a flat surface. If the insert, together with its eggs, is removed from the container and introduced into a pan of water, then the insert stands in the pan on a flat surface. As a result of the punctiform mounting, hot water can flow particularly well around the insert in the pan, so that an even boiling of the eggs is promoted. A point contains one or more standing areas of maximally 4 mm², in particular 1 mm², respectively.

If the insert has a hook for suspension from a pan rim, then the insert can be mounted on the outside or inside of the pan, for example when the boiling water is not yet boiling, so that a kitchen worktop is kept clear. As soon as the water boils, the insert can be unhooked from the pan rim and brought into the boiling water.

A removal of the insert from the container is facilitated by a handle element of the insert. This is expediently disposed in the geometric center of the symmetrical insert, so that a lifting of the insert by the handle does not cause the insert to tilt. Generally speaking, the center of gravity of the insert, when the insert is mounted in the container, expediently lies beneath the handle. A plurality of eggs can thus be arranged all around the handle.

Good haptics can be achieved if the handle element rises up at least twice as high over the base of the container as the highest point of the holding elements which hold the stored eggs radially on the outside. Moreover, the insert having the high handle element can be placed into hot water, the holding fingers being far enough away from the water not to be overheated. The handle element is expediently at least 45 mm, in particular at least 55 mm, high above a base on which the insert stands. In this embodiment, it rises also over the stored eggs and can protect these from pressure from above upon the lid of the container. To this end, the handle element projects from below, in particular, to less than 1 mm from the closed lid of the container.

A universal applicability of the handle elements can be promoted by a movable mounting of the handle element in the insert. In order to avoid burns when the insert is introduced into boiling water, the handle element can advantageously be brought into a lower position and into an upper position further remote from eggs stored in the insert. In the lower position of the handle element, this is disposed close to the eggs, so that a lid of the container can be closed over the handle element. As a result of the movement into its upper position, which expediently amounts to at least 2 cm, in particular at least 4 cm, the handle element can be distanced sufficiently far from the eggs that, even when the eggs are fully washed over by boiling water, it is still far enough away from the water surface and no dangerous heat gets from the boiling water to a finger on the handle element.

In order that the handle element remains in its upper setting and the insert can be removed again from the boiling water without danger, the insert is expediently provided with a means for locking the handle element in its upper position. This means can be a latching means, so that the handle element locks in its upper position. An unlatching can be effected by a gentle pressure from top to bottom upon the handle element, so that the handle element can be returned to its lower position.

In addition, it is advantageous if the handle element has an opening through which a finger can be led, thereby ensuring a secure holding of the insert.

For the storage of at least one egg, the insert is provided with at least one egg holder, expediently with four egg holders. The egg holder is advantageously formed in the shape of a ladle, which holds the egg in its scoop or bowl and, with a segment or holder corresponding to the handle, is connected to the other elements of the insert. Through this shaping of the egg holder, a resilient mounting of the egg in the insert can be achieved, thereby offering high security against damaging of the egg. Expediently, the geometric center of the insert, the holder and the bowl lie in a line. The eggs are thus stored in a circular pattern around the center and can be securely held by little material. A good bathing of the eggs with boiling water can hereby be supported.

A secure storage of the eggs is promoted by a hole in the egg holder in the direction of the base, so that small eggs stand on the edge of the hole. Expediently, the hole has a downward-pointing collar, which stands upright on the base. It is advantageous if the spacing of the hole edge on which eggs stand is at least 1 mm, in order that the egg standing on the hole edge does not at its lowest point rest on the base.

A secure storage of the eggs is further promoted if the bowl of the egg holder has at each place—where necessary except for regions closer than 2 mm to a recess or the rim of the bowl—a, in the mathematical sense, positive curvature. For each point, it is important that the bowl can at no point be developed into a plane. Or: two sectional lines through the bowl, which intersect at a point, are curved in the same direction, namely toward the egg, at the point of intersection. This expediently applies to all straight lines through all points of the bowl, where necessary except for the boundary points.

A good bathing of the stored egg with boiling water can be promoted by an opening which is recessed in the egg holder in its segment corresponding to the handle of the ladle. With equal benefit, in the segment corresponding to the scoop of the ladle, a plurality of recesses are made. Likewise beneficial to a good bathing is an opening in the egg holder downward in the direction of the container.

A secure storage of an egg in the egg holder can be achieved by the egg holder forming a three-point support for holding the egg at precisely three mutually spaced regions. A particularly secure storage of the eggs against impacts can be achieved if the egg holder has a plurality of bearing elements for bearing against the secured egg, at least two of which are configured as spring elements for the resilient holding of the egg. Expediently, the two resilient bearing elements are resilient independently from each other. They can spring en bloc and expediently spring at least 0.2 mm under the weight of a normal or average egg. The spring action can be particularly easily achieved if the resilient bearing elements are realized as fingers.

If the egg holder has moldings for the punctiform holding of the egg—particularly in an otherwise smooth surface—then stored eggs can be well bathed, even in the region of a mounting.

In an advantageous form of the insert, this has a plurality of same egg holders for holding respectively a single egg, which are arranged in the pattern of a carousel in rotational symmetry around a geometric middle of the insert. An economical use of material and a good bathing of the eggs can be achieved with a specific embodiment in which each insert is mutually distanced around the middle from its two neighboring inserts outside of a radius passing through the centers of stored eggs.

A further advantageous embodiment of the invention provides that the insert comprises at least one egg holder for holding a single egg and at least one foot for standing on a flat surface, so that the egg holder is distanced from the surface. Consequently, the stored eggs, on the one hand, are well protected in the container against impacts from below and, on the other hand, can be well bathed from below when the insert is arranged in a pan of boiling water. Expediently, the egg holder is realized such that it springs relative to the surface or to a base of the container, a spring deflection under the weight of a normal or average or medium-sized egg amounting to around at least 0.2 mm, expediently 0.5 mm, in particular 1 mm.

A stable standing of the insert both in the container and in a pan can be achieved if the insert comprises a plurality of egg holders for holding respectively a single egg and a plurality of feet for standing on a flat surface, a foot being always provided between adjacent egg holders.

The insert and with it, expediently, a plurality of eggs, can be easily removed from the container and placed in a pan of boiling water. The eggs are securely mounted during the boiling and a banging together of the eggs, and, in particular, a banging of the eggs against the pan bottom or side walls, can be reliably prevented.

To this end, the insert is advantageously removed from a container of the egg transport container by a handle element and, with the handle element held fast, is deposited into boiling water in the pan. A plurality of eggs can thus be transported with a handle directly from the egg transport container into the pan.

Advantageously, the handle element, prior to the removal of the insert from the container, is drawn out with the aid of a pull-out and is thus moved away from the eggs and locked in a remote position. As a result of the remote position, the insert can be introduced into the hot water and deposited in the pan without risk of the user being burnt.

Expediently, the insert is shaped and the water level chosen such that the hot water washes over the insert except for a central region. A good bathing of the eggs can be achieved with the specific embodiment in which the radius of the central region parallel to the water level constitutes less than 60% of the total radius of the insert. If the handle element rises up higher over the hot water than the water is deep, the handle can be securely grasped without the fingers becoming too hot.

For a good boiling of the eggs, a suitable water level in the pan, which must not be too high, must be selected to allow the insert to be placed into the pan of hot water without burns. The establishment of the suitable water level or water depth in the pan is facilitated if the insert has a structural element having a horizontal edge which expediently is roughly level with the suitable water depth. The quantity of water in the pan is advantageously chosen such that the edge is less than 5 mm beneath the water surface.

For cost reasons and for preserving environment it is desirable to boil eggs by using little energy. This can be achieved by using little water in the pan while boiling the eggs. It is easily possible to prepare boiled eggs which are uniformly cooked throughout their volume without completely covering the eggs with boiling water. A water level between 8 mm and 15 mm is sufficient for perfectly boiling eggs. However, for achieving a uniform cooking throughout the whole volume of an egg it should be kept at a distance from the pan base during the boiling procedure. Otherwise, when using little water and the eggs lying straight on the bottom of the pan, the egg might be heated stronger from the bottom being strongly cooked on the bottom and less cooked on top. The distance of the eggs to the bottom of the pan is easily achieved by using the insert for boiling the eggs. The insert always keeps some water between the eggs and the bottom of the pan and thus keeps the temperature of the bottom of the eggs at the same level—namely the temperature of boiling water—than on the top of the eggs, which are positioned in hot steam having the same temperature. With this the use of little water is facilitated. The finding of a suitable water level is facilitated by any structural element indicating a suitable water level in the pan, like the horizontal edge, a horizontal marker or any other suitable element.

In addition, it is advantageous if the insert is hung over a rim of the pan, since a support surface can thereby be spared.

With the above and other objects in view there is also provided, in accordance with the invention, a merchandising method, which comprises:

providing, at a merchant's, an egg transport container as outlined above;

offering for sale individual eggs for selection and purchase by a consumer, and prompting the consumer to place eggs selected for purchase into the egg transport container;

at the merchant's checkout, testing whether the egg transport container is a newly purchased container or the egg transport container had been previously obtained by the consumer and brought to the merchant's;

if the egg transport container is determined to have been previously obtained by the consumer, discounting a price of the eggs to be purchased and transported in the egg transport container, and selling the eggs at a discounted price.

In accordance with an additional feature of the invention, if the egg transport container is determined to not have been previously obtained (e.g., purchased) by the consumer, identifying the container and tagging the container to a customer's identification. When the consumer brings the container back for another purchase, the checkout register will immediately recognize the container and thus provide for the advertized discount.

Other features which are considered as characteristic for the invention are set forth in the appended claims.

Although the invention is illustrated and described herein as embodied in an egg transport container and use of an insert of an egg transport container, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows an egg transport container having two removable inserts disposed in a container;

FIG. 2 shows an insert in a side view in the container;

FIG. 3 shows a further insert in a side view;

FIG. 4 is a perspective view of two further inserts; and

FIG. 5 is a flowchart illustrating a novel merchandising and distribution system.

### DETAILED DESCRIPTION OF THE INVENTION

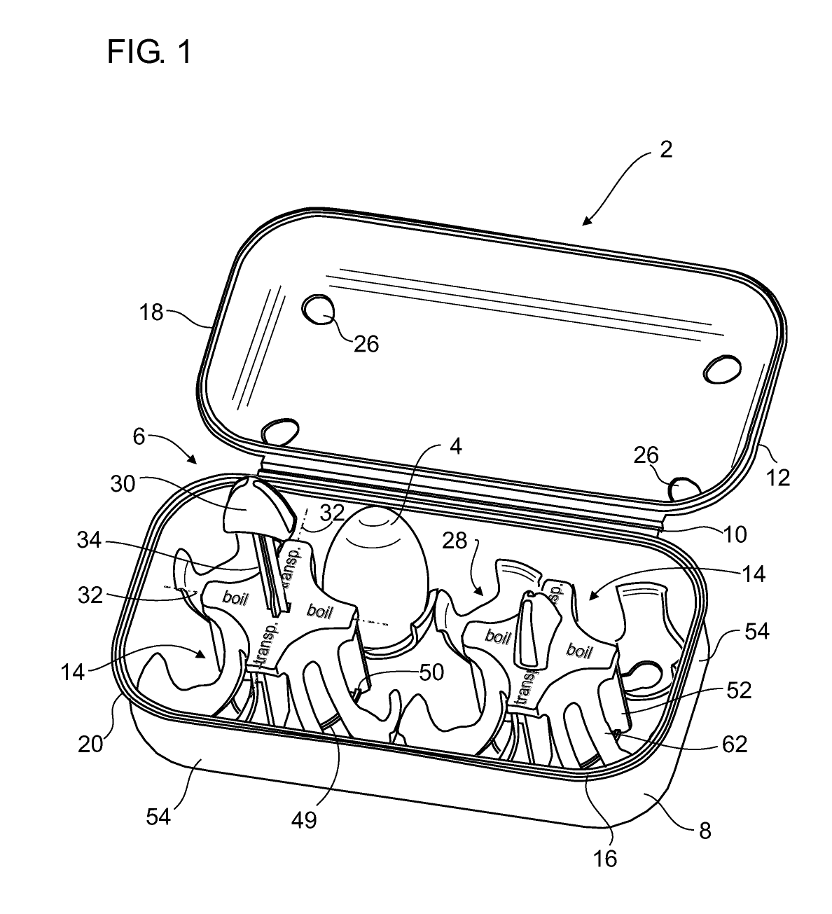

Referring now to the figures of the drawing in detail and first, particularly, to FIG. 1 thereof, there is shown an egg transport container 2 for transporting and storing eight eggs 4, of which, for the sake of clarity, only one egg 4 is represented in the figure. The egg transport container 2 consists of a container 6 in the form of a plastics box having a bottom tray 8 which is fixedly connected by a film hinge 10 to a lid 12 of the container 6, and two inserts 14. For the closure of the container 6, the lid 12 can be swung onto the bottom tray 6 by virtue of the slight mobility of the film hinge 10, whereupon a groove 16 in the rim of the container 6 receives a tongue 18 in the rim of the lid 12 in the manner of a tongue and groove joint. This can be realized in clamping fashion, so that the container 6 is closed, or the lid 12 can remain held against the bottom tray 8 with the aid of a fastener (not represented), for example with the aid of a latching clip, which in the closed state of the container 6 can be latched in place under a bead 20 on the rim of the bottom tray 8.

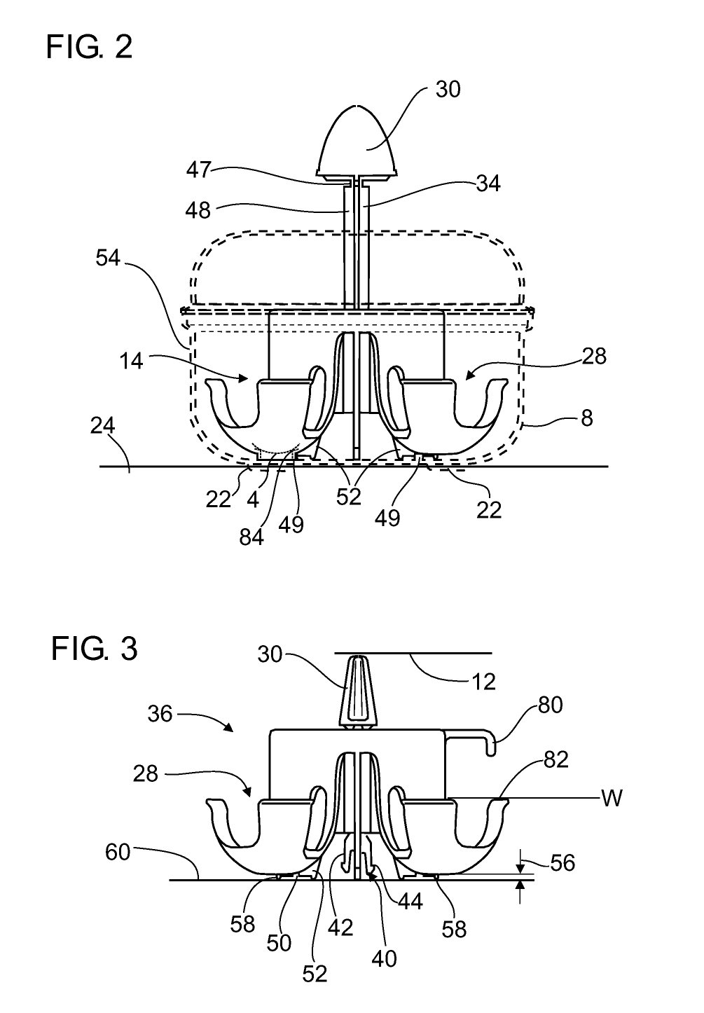

FIG. 2 shows one of the two inserts 14 in a side view, the container 6 being indicated in dashed representation around the insert 14. On its bottom tray 8, the container 6 is provided with four moldings 22, which serve as feet on which the container 6 stands on a smooth surface 24, for example of a kitchen work top. The moldings 22 are disposed exactly opposite air vents 26 in the lid 12 of the container 6, so that, when two containers 6 are stacked one above the other, the moldings 22 of the top container 6 engage in the air vents 26 of the bottom container 6. As a result of such a form lock (i.e., form closure, positive engagement, positive form lock) of two containers 6 stacked one on top of the other, a slippage of the upper container relative to the lower container can be prevented and a stable stack of containers 6 stacked one above the other can be formed.

The two inserts 14 are respectively designed to hold four eggs 4, each insert 14 having four egg holders 28, which are arranged in a circular pattern and symmetrically around a handle element 30 of the insert 14. The inserts 14 are respectively realized in mirror symmetry to two perpendicular planes 32 arranged perpendicularly to each other, which in FIG. 1 are indicated by, respectively, a dash-dot line. As a result of this double mirror symmetry, the center of gravity of the insert 14 without eggs 4, with two mutually opposing eggs or four same eggs 4 is located in the line of intersection of the two planes of symmetry 32, which line also runs through the handle element 30. By virtue of this arrangement of the handle element 30, an insert 14 can be lifted upward by the handle element 30 without tilting of the insert 14. Even if the insert 14 is removed from the container 6, the eggs 4 thus remain stored in a stable and secure manner.

For even safer transport of the inserts 14 removable from the container 6, the handle element 30 is connected to a pull-out 34, which can be pulled upward relative to the egg holders 28, so that the handle element 30 is movably mounted in the insert 14 such that it is upwardly and downwardly displaceable. In FIG. 1, the handle element 30 on the left insert 14 is represented in its pulled-out and upper position and on the right insert 14 in its lower position, in which the lid 12 can be swung down over the insert 14 and handle element 30 and the container 6 can be closed.

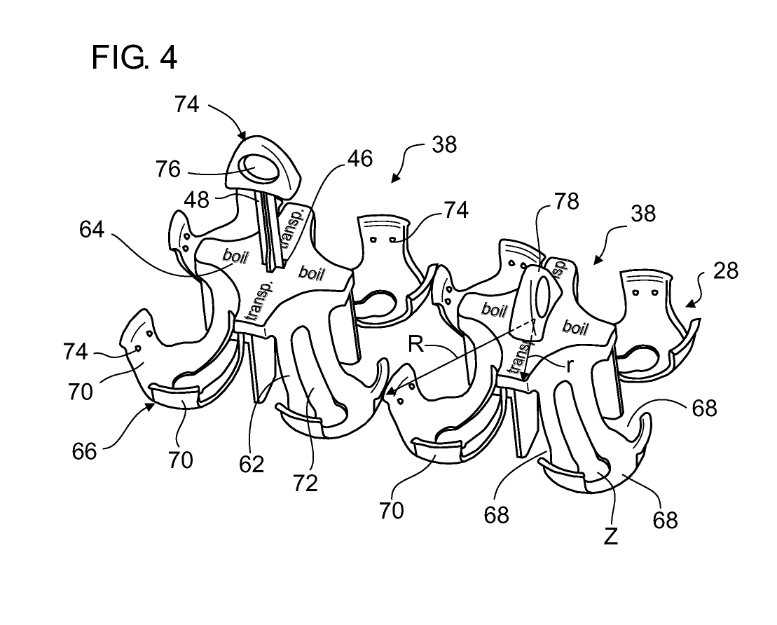

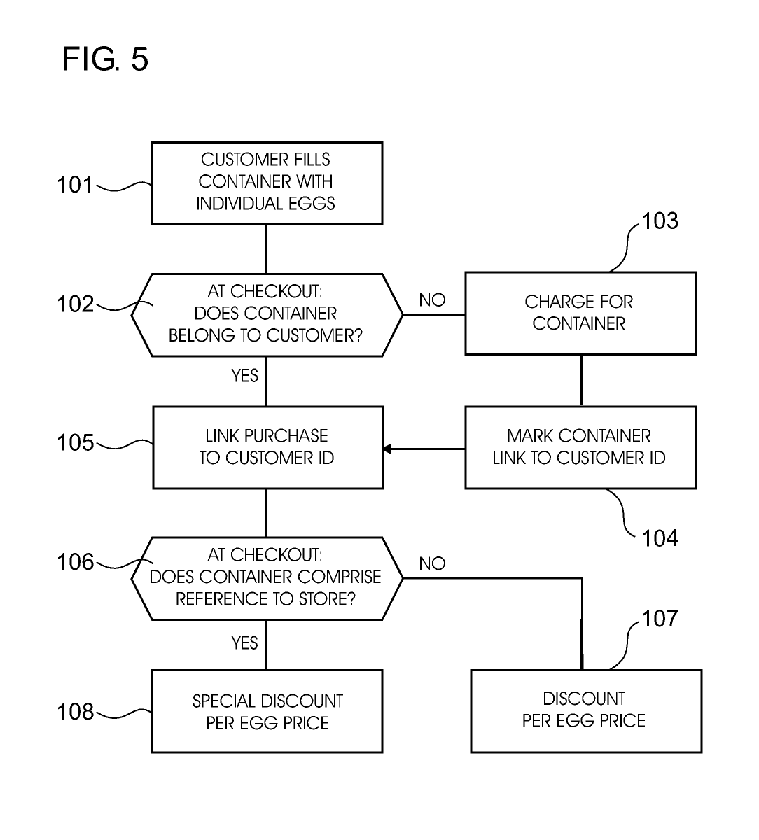

In FIGS. 3 and 4, alternative inserts 36, 38 are respectively represented, which conform, however, in their predominant details, to the inserts of the illustrative embodiment from FIGS. 1 and 2. The different details of the illustrative embodiments are all optionally interchangeable and combinable and are both individually usable in their own right and mutually combinable in any chosen number. They are not all represented in every figure, purely for the sake of clarity. Substantially constant components are basically labeled with the same reference symbols, and unmentioned features are adopted in the following illustrative embodiments without being newly described.

In order that the handle element 30 can be locked in its upper position, each insert 14, 36, 38 comprises a locking means 40 in the form of a latching element, by which the handle element 30 can be locked in its upper position. The locking means 40 is provided with four arms 42, which are elastically bendable perpendicularly to a motional direction of the handle element 30. Onto the arms 42 there is respectively formed a molding 44, by which a detachment of the handle element 30 from the other elements of the insert 14 is prevented. In the upper position of the handle element 30, the arms 42 are introduced in clamping fashion into an opening 46 (see FIG. 4), whereupon the moldings 44 back-grip rims of the opening 40 in a middle element 64 and support the weight of the other parts of the insert 14, together with the four eggs 4, when the handle element 30 is held. The locking mechanism can be released by the handle element 30 being pressed somewhat more strongly downward, so that the clamp fastening is undone and the handle element 30 is returned into its lower position.

The handle element 30 is also lockable in its lower position in order to allow transport of its insert 14 in the non-pulled-out state of the pull-out 34. To this end, the handle element shall be twisted about 90°, as represented in FIGS. 1 and 4. The twisting of the pull-out 34 in the opening 40 in the lower position of the handle element 30 is enabled by a recess 47 (FIG. 2) in the pull-out 34. As a result of different dimensions in terms of thickness and depth of the crossed-over webs 48 of the pull-out 34, these, in the bottom-locked state, back-grip the rims of the opening 40 in the middle element 64 and hold the handle element 30 in its lower position. In order to prevent accidental twisting of the pull-out 34 in the opening 40 during transport of the insert 14, the middle element 64 can have in its bottom side a small recess, in which one or more webs 48 in the locked state engage and thus form a form closure with the middle element 64. For the safe recognition of the respective position of the handle element 30, the middle element 64 is provided on its top side with the characters “Transp.” for transport in the lower setting of the handle element 30 and “Boil” for the upper setting of the handle element 30.

Regardless of whether the handle element 30 is movable or not relative to the rest of the insert 36, its height is chosen such that it rises up to just below the closed lid 12, as indicated in FIG. 3, or butts against the same. A gap between the handle element 30 and the lid 12 is in any event less than 1 mm.

The handle element 30 rises to about 60 mm over a base 60 and is hence just about three times as high over the base 60 as upper edges 82 of bearing segments 70. These edges 82 are realized horizontally and serve as water level indicators, according to which a quantity of water suitable for boiling can be poured into the pan. The water depth W indicated in FIG. 3 should be such that the edges 82 are just washed over.

For the secure and fixed standing of each insert 14 in the container 6, the bottom tray 8 and the inserts 14 interlock positively. In the illustrative embodiment shown in FIGS. 1 and 2, this form closure is effected by an annular molding 49 in the base of the bottom tray 8, which engages in corresponding recesses 50 in feet 52 of the inserts 14. If this form closure is achieved when the inserts 14 are inserted into the container 6, then the inserts 14 are prevented from moving parallel to the surface 24 or parallel to the base of the bottom tray 8 relative to the container 6, so that slippage of the inserts 14 in the container 6 is avoided. In this position, the inserts 14 are arranged in the container 6 such that they are distanced somewhat from the side walls 54 of the container 6, as can be seen in FIG. 2. Hence the held eggs 4 are also distanced somewhat from the side walls 54, so that an impact upon the side walls 54 is not transmitted directly to the eggs 4.

Alternatively, the form closure can permit a defined lateral clearance of the insert 14 in the container 6 of between 1 mm and 3 mm, so that the insert 14 and the eggs stored therein, in case of a lateral impact, can move sideways en bloc in accordance with the clearance.

The feet 52 are dimensioned in their arrangement such that they keep the egg holders 28 distanced from the surface 24 by a distance 56 when the insert 14, 36, 38 stands on the surface 24. When the insert 14, 36, 38 is mounted on the surface 24, the egg holders 28 thus do not touch the surface 24, so that the egg holder 28 and eggs 4 are prevented from banging on the surface 24. Moreover, the four feet 52 of each individual insert 14 are provided with respectively two elevations 58, on which the insert 14 rests in each case punctiformly on the surface 24. If the insert 14 is introduced into a pan of boiling water and stands with the elevations 58 on a pan bottom 60 analogously to the surface 24, then the feet 52 can be largely bathed with water, so that a good bathing of the eggs 4 with boiling water is ensured.

The four egg holders 28 of an insert 14, 36, 38 are respectively shaped in the style of a ladle and are fastened with a segment 58 corresponding to the handle of the ladle to a middle element 64 of the insert 14, and hence indirectly to one another. The four same egg holders 28 are arranged in the pattern of a carousel in rotational symmetry around a geometric middle of the insert 14, 36, 38. As can be clearly seen from FIG. 4, each egg holder 28 is distanced, radially on the outside, from its two neighboring egg holders 28. The radius r of the central region 64 or middle elements 64, in which central region the egg holders 28 are joined together, here measures less than half the maximum radius R of the insert 14, 36, 38. If an imaginary circle is placed through the centers Z of the circular-segment-shaped parts of the openings 72, which lie directly beneath the centers of the stored eggs, then the egg holders 28 are separated and distanced from one another radially outside of this circle.

As a result of the realization of the insert 14 from an elastic plastic, the egg holders 28 in the segment 62 spring downward when an egg 4 is placed into the egg holder 28, so that the egg 4 is resiliently mounted in the egg holder 28. Though an impact from below onto the container 6, or from the side, is thus transmitted directly to the feet 52, and hence to the insert 14, 36, 38, as a result of the resilient mounting of the eggs 4 in the segments 62, it is to some extent absorbed, so that the eggs 4 are stored in the container 6 in a very transport-proof manner.

For better bathing of the eggs 4 in the pan, a segment 66, which in its shaping imitates the scoop of the ladle, is provided with three recesses 68, so that the egg holder 28 has two finger-like bearing segments 70. An egg 4 in the egg holder 28 is hereby mounted on the two finger-like bearing segments 70 and on the segment 62, in the manner of a three-point support, at three mutually spaced regions. As the result of an opening 72, which helps boiling water to flow around a held egg 4 and leads to below the egg 4, one of the three bearings can be divided into two very close-together bearing points, whereby the effect of the three-point support is unimpaired.

Another embodiment of the opening 72 is indicated in FIG. 2. The opening is provided with a circular-segment-shaped collar, which points to the base 60 and on whose inner edge 84 stands an egg. The egg holder 28 stands with the collar on the base and is thus downwardly supported.

The finger-like bearing segments 70 are likewise already in themselves elastic, so that a placement of a middle egg 4 into the egg holder 28 leads to a slight expansion of the finger-like bearing segments 70 of at least 0.3 mm. The egg 4 is hence securely mounted and, in case of a strong impact upon the container 6 from below, slips only a little bit deeper into the egg holder 28 and thus expands the finger-like bearing segments 70 a little bit further, without these, however, coming from below directly into contact with the egg holder 28. This creates a very impact-resistant storage.

In order to achieve a punctiform mounting of an egg 4 in the egg holder 28, the egg holder 28 can have moldings 74, which are directed toward the egg and against which a held egg 4 punctiformly bears. A bathing of a held egg 4 with boiling water in the pan, and hence a quick and even boiling of the egg 4, is thereby promoted.

In the illustrative embodiment shown in FIG. 4, the handle element 76 is provided with an opening 78, as a result of which two fingers, which hold the handle element 76 on both sides, can touch each other through the handle element 76. A slipping of the handle element 76, and thus of the insert 38, from the holding fingers is thereby prevented.

In the illustrative embodiment represented in FIG. 3, the insert 36 is provided with a hook 80 with which the insert 36 can be hung over a pan rim. The hook 80 is arranged symmetrically between two egg holders 28, so that the insert 36, in the suspended state, lodges with the egg holders 28 against the outside of the pan rim and the insert 36 is hence held at three points: by the hook 80 and by the two egg holders 36.

The above-described egg transport container is advantageous in another respect. The container may be an integral part of a system in which packaging waste in the context of egg sales and distribution can be largely avoided. It is still conventional in the United States to distribute and sell eggs in non-recyclable containers. The containers, or egg crate boxes, accommodate four, six, eight, or any other number of eggs. They are made of polystyrene, of packed cardboard, or the like. These materials cannot be recycled and they add a considerable amount of garbage waste volume. A novel concept is provided herein which enables consumers to do their part in the context.

The novel process involves personal ownership of the container. The customer fills 101 a container with loose eggs. The container may be any container, e.g. a container which is not his own and which he grasps in the store, or a container he already bought in a previous shopping in the store, or any other container belonging to him. At checkout it is checked 102 whether the container belongs to the customer. Upon the first purchase 101 of the container (with or without eggs), the container is marked as belonging to the customer 102. This may be effected simply by removing a store tag, by canceling an integrated magnetic ID, or by uniquely assigning the container to the consumer, preferably to an ID of the customer. If, for example, the system is operated only out of a single store, or a chain of stores, it may not be necessary to identify the container, except that the container may be provided with a specific store branding. In the alternative, the egg transport container may carry an identification (UPC, ID number, RFID chip, name, etc.) that links the container to the consumer and the corresponding information may be stored in the store's computer system. This, furthermore, allows the store to monitor consumer behavior with regard to egg purchases.

Then the container is checked 106 as one that is related to the store or the chain of stores or any network of stores to which the store belongs. This can be done by checking any reference to the merchant's on or in the container, like a branding mark of the store or chain of stores on the container or the identification of the container. If the container is not related to the store or chain or stores, because it is any private container or a container related to another store or chain of stores, the customer is charged with the discounted price of loose eggs 107. This price accounts for the savings in packaging and containers and includes a discount with respect to ordinary packed eggs. The discount may be in the range of one to several pennies per egg, depending on the cost to the merchant and the desired effort to be expended in furthering the system. On the other hand, if the container is related to the store or chain or stores, a special discount is directly credited to the customer 108. This special discount may be credited on top of the savings due to packaging and containers, or may be an alternative discount credited instead of the savings due to packaging and containers. Of course, the further check may be omitted granting any discount to anyone purchasing loose eggs in a container related to the store or not.

The novel distribution system is a win-win for the consumer and the merchant. Due to the discount the egg purchaser receives, the cost for the transport container is quickly amortized. And he may buy exactly the number of eggs he needs and not any number predetermined by a box size. Further, the transport of the eggs and the storing and handling at home is considerably facilitated. The advantages for the merchant are also manifold: egg sales may be effected without any packaging waste because the egg cartons with which the eggs are delivered to the store are returned to the wholesaler for reuse and further shipments. Further, the merchant is able to sell fresh eggs individually with a minimum in handling effort. Finally, consumer loyalty to the merchant is clearly furthered with the system. The advantages to the environment, of course, are immediately evident.

In most stores eggs of different quality are sold. To avoid confusion at checkout, preferably only one class of eggs is sold loosely. These eggs should fulfilling a predefined standard, preferably regarding size and production methods. If a high standard of the loose eggs is communicated to the customer, the customer may easily find the high standard eggs he wants without any need to check any brand or quality description on a standard egg box. The purchase of high quality eggs is facilitated for the customer, and the merchant may sell more eggs fulfilling the high quality standard. Since the eggs are defined by the predetermined standard the merchant may sell any eggs fulfilling this standard independent of the manufacturer of the eggs. Further he may create an own egg brand or use a brand of a manufacturer network willing to fulfil the predefined standard.

Another advantage of the novel process arises for manufacturers of eggs. A store may cooperate with a group of egg manufacturers delivering their eggs to the store. The manufacturers do not need an own and known brand to sell their eggs, but may sell their eggs under the selling system and/or the brand of the store. By this, with a chain of stores, a network of manufacturers or a network of groups of manufacturers may easily distribute their eggs under the selling system and/or the brand of the chain of stores without the need of an organizing company for each group or for the network. Each store may select its own egg suppliers bound by contract to the predefined quality standard and delivering eggs to the store or a central market for the stores. By this the manufacturers save marketing expenses which may be discounted to the customer. This savings may be passed on to the customer, so, a high quality egg may be sold at the same price as a medium quality egg lying adjacent in the stores shelf. With this method high quality farming is supported and animals and environment are treated with care.

1. An egg transport container for transporting and storing a plurality of eggs, comprising:
an outer container;
at least one insert removably disposed in said outer container, said at least one insert being configured to secure one or more eggs within said container.

2. The egg transport container according to claim 1, wherein said container is formed with at least one air vent and, in a side lying opposite the air vent, with a molding for engaging in an air vent of a further egg transport container stacked above or below.

3. The egg transport container according to claim 1, wherein said outer container is formed with a closable lid, and said insert has a given height defining a vertical clearance of less than 1 mm to a horizontal and highest region of said lid when said container is closed.

4. The egg transport container according to claim 1, wherein said insert is mounted in said container with a defined lateral clearance of between 1 mm and 3 mm, so that said insert and the eggs stored therein, in case of a lateral impact, move sideways en bloc in accordance with the clearance.

5. The egg transport container according to claim 1, wherein said insert is a one-piece integral insert provided with a foot for standing on a base of said container, and wherein said foot and the base of aid container) are form-locked and said insert is removable from said container in an upward direction.

6. The egg transport container according to claim 5, wherein said insert projects in lateral directions beyond said foot and said form lock secures said insert against slippage on the base in two mutually perpendicular directions.

7. The egg transport container according to claim 1, wherein said insert is formed with a foot for standing on a base of said container, and said foot stands with an elevation punctiformly or linearly on a flat surface of the container.

8. The egg transport container according to claim 1, wherein said insert is substantially symmetrical and has a geometric center, and said insert includes a handle element disposed at said geometric center and for removing said insert from said container.

9. The egg transport container according to claim 8, wherein said handle element rises up at least twice as high over the base of the container as a highest point of elements holding the eggs radially on the outside.

10. The egg transport container according to claim 8, wherein said handle element is movably mounted in said insert between a lower position and an upper position farther remote from the eggs stored in the insert.

11. The egg transport container according to claim 10, wherein said insert includes locking means for locking said handle element in the upper position.

12. The egg transport container according to claim 1, wherein said insert has at least one egg holder for holding a single egg, and said egg holder is formed as a ladle having a holder, corresponding to the handle of the ladle, and a bowl.

13. The egg transport container according to claim 12, wherein said egg holder has a plurality of bearing segments for bearing against an egg secured therein, and at least two of said bearing segments are configured as spring elements for resiliently holding the egg.

14. The egg transport container according to claim 1, wherein said insert has a plurality of substantially identical egg holders each for holding a single egg, and arranged in a pattern of a carousel in rotational symmetry around a geometric middle of said insert.

15. An insert of an egg transport container assembly, comprising:
an insert body configured to be placed in an egg transport container and being configured to hold eggs in a pan during the boiling of the eggs;
said insert body having a geometric center; and
a central handle element at the geometric center of said insert body, said central handle element enabling a removal of said insert body from the egg transport container of the egg transport container assembly and, with said handle element grasped, to be deposited in at least 80° C. hot water in the pan.

16. The insert according to claim 15, wherein said handle element, prior to the removal of said insert from the container, is extended out with the aid of a pull-out and moved away from the eggs and locked in an extended, remote position.

17. The insert according to claim 15, wherein said insert body is formed such that, when said insert body is placed in the pan, the hot water washes over said insert body except for a central region, and a radius of the central region parallel to a water level accounts for less than 60% of a total radius of said insert body.

18. The insert according to claim 17, wherein said handle element rises up higher above a hot water level than a depth of the water.

19. A merchandising method, which comprises:
providing, at a merchant's, an egg transport container according to claim 1;
offering for sale individual eggs for selection and purchase by a consumer, and prompting the consumer to place eggs selected for purchase into the egg transport container;
at the merchant's checkout, testing whether the egg transport container is a newly purchased container or the egg transport container had been previously obtained by the consumer and brought to the merchant's;
if the egg transport container is determined to have been previously obtained by the consumer, discounting a price of the eggs to be purchased and transported in the egg transport container, and selling the eggs at a discounted price.

20. The method according to claim 19, checking whether the egg transport container comprises a reference to the merchant's and discounting a price of the eggs to be purchased and transported if the container comprises such reference.

21. The method according to claim 19, the merchant selecting egg manufacturers and setting a defined quality standard for eggs to be delivered from the manufacturers and selling these eggs as the individual eggs for transporting in the egg transport container by the customer under indication of the quality standard for the customer.

22. A method of boiling eggs, which comprises:
providing an egg transport container according to claim 1;
removing an insert with at least one egg from the outer container by holding the insert at a geometrically central handle element of the insert; and
with the handle element held fast, placing the insert with the at least one egg in a pan holding hot water having a temperature of at least 80° C.

23. The method according to claim 22, which comprises placing the insert so that the hot water washes over the insert except for a central region, whose radius parallel to the water level accounts for less than 60% of a total radius of the insert.

24. The method according to claim 22, which comprises lifting the handle element to rise up higher above the hot water than the water is deep.
